(19) United States
(12) Patent Application Publication
(10) Pub. No.: US 2025/0392379 A1
(43) Pub. Date: Dec. 25, 2025

(54) METHOD FOR SATELLITE SELECTION AND HANDOVER FOR VEHICLE-MOUNTED USER TERMINALS

(71) Applicant: FCA US LLC, Auburn Hills, MI (US)

(72) Inventors: Priyank Mittal, Bengaluru (IN); Matthew J. Mazurek, Auburn Hills, MI (US); Laurent Dizambourg, Poissy (FR); Saleh Bensator, Poissy (FR)

(21) Appl. No.: 18/749,929

(22) Filed: Jun. 21, 2024

(51) Int. Cl. H04B 7/185

(52) U.S. Cl. CPC H04B 7/18541

(57) ABSTRACT

A method for satellite selection and handover for use with a vehicle-mounted user terminal and a low Earth orbit (LEO) satellite constellation having a number of LEO satellites. The method uses an expected future location of the vehicle-mounted user terminal, as well as other optional factors, to preemptively devise a “handover plan” that identifies optimum satellite candidates before a satellite handover is urgently required. In one embodiment, the method may use a predetermined navigational route for the vehicle and ephemeris data for the LEO satellite to devise the handover plan. The present method may reduce instances where there is a loss of service, reduce the overall number of satellite handovers needed, and/or better utilize communication resources.

### FIELD

The present disclosure relates to a method for satellite selection and handover and, more particularly, to a method that uses vehicle-, satellite- and/or Earth-related information for satellite selection and handover involving vehicle-mounted user terminals and Low Earth Orbit (LEO) satellites.

### BACKGROUND

LEO satellites travel very quickly and have orbits that are much closer to Earth than other types of satellites, such as geosynchronous (GEO) satellites, such that they typically complete an entire orbit around the Earth in less than 2 hours. Consequently, the period of time when a particular LEO satellite is in communication range with a user terminal is fairly short. This necessitates the need for frequent satellite handovers where a satellite connection with the user terminal is passed from one LEO satellite to the next.

The need for frequent satellite handovers is further exasperated when the user terminal is installed on a vehicle that is travelling in a direction that diverges from the orbital path of the LEO satellite to which it is connected. The rotation of the Earth can also contribute to the need for frequent satellite handovers. Each satellite handover, which involves rapidly disconnecting from one LEO satellite and connecting to another, can cause a certain amount of delay and latency in the satellite connection and consumes communication resources.

Thus, it would be preferable to provide a method that optimizes satellite selection and handover by reducing the number of satellite handovers required for a user terminal installed on a vehicle.

### SUMMARY

In at least some implementations, there is provided a method for satellite selection and handover using a vehicle-mounted user terminal and a low Earth orbit (LEO) satellite constellation having a plurality of LEO satellites, the method comprising the steps of: initiating a new satellite connection request from the vehicle-mounted user terminal to the LEO satellite constellation; establishing a first satellite connection between the vehicle-mounted user terminal and a first satellite of the plurality of LEO satellites; gathering vehicle-related information that includes vehicle navigation information and satellite-related information that includes ephemeris data for the plurality of LEO satellites; using the vehicle-related information and the satellite-related information to identify candidate satellite(s) from the plurality of LEO satellites that are likely to be in range of the vehicle-mounted user terminal during a future timeframe; prioritizing the candidate satellite(s) for one or more satellite handover(s) to be carried out during the future timeframe; and performing a satellite handover and establishing a second satellite connection between the vehicle-mounted user terminal and a second satellite of the plurality of LEO satellites, wherein the second satellite is prioritized among the candidate satellite(s).

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic view of the Earth and several LEO satellites that are part of a larger LEO satellite constellation;

FIG. 2 is a schematic view of several LEO satellites and their corresponding footprints and spotbeams;

FIG. 3 is a graph of signal strength of a satellite connection between a vehicle-mounted user terminal and one or more LEO satellite(s); and

FIG. 4 is a flowchart illustrating an example of a method for satellite selection and handover.

### DETAILED DESCRIPTION

Referring in more detail to the drawings, there is described a method for satellite selection and handover. The method may be particularly useful for user terminals that are installed on vehicles and that communicate with various LEO satellites.

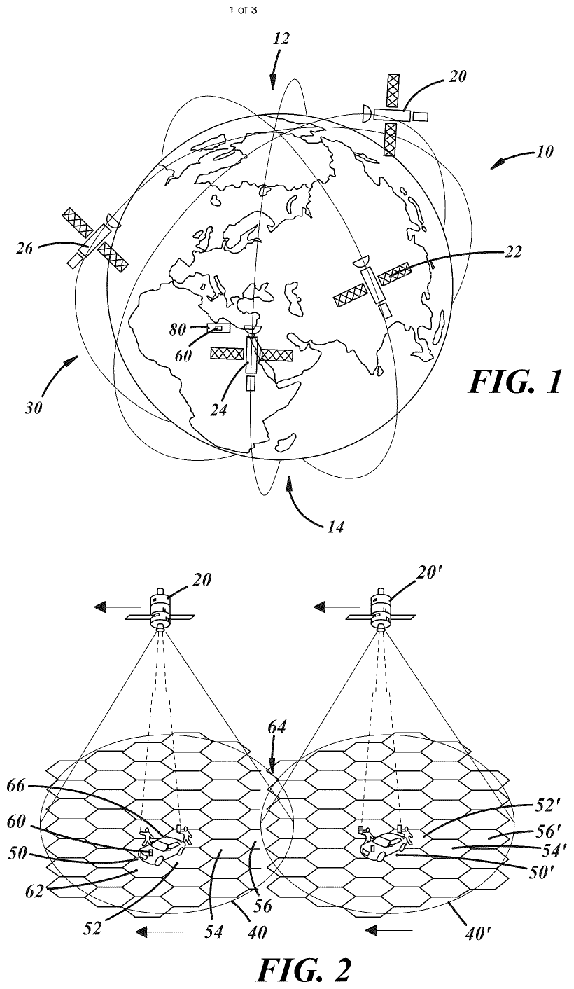

Turning to FIG. 1, there is shown a schematic illustration of the Earth 10 and several Low Earth Orbit (LEO) satellites 20-26 that are part of a larger LEO satellite constellation 30. Skilled artisans will appreciate that LEO satellites orbit the Earth at altitudes that are typically less than about 3,000 km or 1,800 mi. It is possible for some elliptical LEO orbits to temporarily leave a LEO region surrounding the Earth when their highest altitude or apogee exceeds 3,000 km, but most LEO satellites orbit entirely within the LEO region. LEO satellites orbit much closer to Earth than geosynchronous (GEO) satellites, which are usually at altitudes greater than 30,000 km or about 18,000 mi. Because of their relatively low orbit, LEO satellites tend to quickly move or arc across the sky. A LEO satellite can have an orbital period that is less than 2 hours such that it orbits the Earth more than 10 times per day. Accordingly, a LEO satellite is typically only in communication range with a specific location on Earth for 15-30 minutes per pass. A user terminal typically has a selection of LEO satellites with which to connect. The closer a user terminal is to one of the poles 12, 14 of the Earth, the more LEO satellites there are to connect with, due to the orbit configuration of the LEO satellite constellation 30.

LEO satellite constellations have a number of advantages over GEO satellite constellations, including: more efficient bandwidth usage, lower propagation delays, and lower power consumption by both the satellites and the user terminals. However, one challenge with a LEO satellite constellation is that, due to their low orbit and high velocity, each LEO satellite only stays within view of a specific location on Earth for a short period of time (15-30 minutes). This causes a user terminal to have to frequently disconnect from a LEO satellite exiting its field of view, identify another LEO satellite entering its field of view, and connect to the entering LEO satellite all at a rapid pace and with minimal delay and latency. This process of connecting, disconnecting and reconnecting is referred to as a “handover” and can be made even more challenging when the user terminal is installed on a vehicle, which can be driving in a direction that diverges from the orbital path of its corresponding LEO satellite. The present method is designed to improve the satellite handover process, particularly as it applies to user terminals installed on vehicles, and reduces the amount of communication resources that are required.

Satellite handovers involving LEO satellites can generally be divided into two primary categories: “network layer handovers” and “link layer handovers.” Before discussing these different categories of handovers, it may be useful to describe how a LEO satellite communicates with user terminals on Earth, as well as other satellites. With reference to FIG. 2, there is shown a schematic diagram of two LEO satellites 20, 20′ that may be within the same orbit or plane as one another (intraplane satellites) or they may be in adjacent orbits or planes (interplane satellites). Each LEO satellite 20, 20′ respectively has its own footprint 40, 40′, which is a circular area on the Earth's surface below the satellite and is further divided into a number of smaller spotbeams or cells 50-56, 50′-56′, respectively. Different schemes for cellular coverage geometry may be employed, including satellite fixed cell (SFC) schemes and Earth fixed cell (EFC) schemes. The spotbeams or cells of LEO satellites are typically larger than corresponding cells in terrestrial-based cellular communication networks.

Network layer handovers, also referred to as higher layer handovers, are used when a communication endpoint (e.g., a satellite or a user terminal) changes its internet protocol (IP) address. A network layer handover migrates or transitions existing satellite connections of higher level protocols (e.g., TCP, UDP, SCTP, etc.) to a new IP address in order to provide uninterrupted data communication. Network layer handovers may utilize different schemes, such as, hard handover schemes where a current link is released before a new link is established, soft handover schemes where a current link is not released until a new link is established, or signaling diversity schemes which are similar to soft handover schemes, except that signals are sent through both current and new links.

Link layer handovers involve a transfer of an ongoing satellite connection to a new spotbeam within the same footprint or to a new LEO satellite. There are several different types of link layer handovers, including: “spot beam handovers,” “satellite handovers” and “intersatellite links handovers” (ISL handovers). The present method is primarily, although not exclusively, focused on satellite handovers.

A spot beam handover involves switching a connection between different spotbeams or cells within the same footprint and is, therefore, considered an “intrasatellite handover.” To explain, as LEO satellite 20 in FIG. 2 rapidly travels in its orbit, its corresponding footprint 40 with its numerous spotbeams 50-56 quickly moves across the surface of the Earth 10. At a particular point in time, a first spotbeam 50 covers user terminal 60 which is installed on vehicle 66 so that a first up/down link can be established. But as the first spotbeam 50 moves across the surface of the Earth, it will eventually no longer cover user terminal 60. As spotbeam boundary 62 crosses user terminal 60, the user terminal enters a second spotbeam 52 which is adjacent the first spotbeam 50. This transition of user terminal 60 from first spotbeam 50 to second spotbeam 52 requires a spotbeam handover. Due to the rapid speed of LEO satellites and the relatively small coverage area of their spotbeams, spotbeam handovers take place quite frequently (e.g., every 1-2 minutes).

A satellite handover, on the other hand, involves switching or transitioning a satellite connection from one LEO satellite to another LEO satellite in the same constellation. For instance, once the footprint 40 of LEO satellite 20 moves across terminal 60, a footprint boundary 64 between adjacent footprints will cross the user terminal and a satellite handover will be needed to transfer the satellite connection from LEO satellite 20 to LEO satellite 20′. This is an example of an “intersatellite handover.”

An ISL handover occurs due to changes in connectivity patterns of the LEO satellites. As an example, if an interplane ISL connection between LEO satellite 20 and another LEO satellite in a neighboring orbit (not shown) is going to be temporarily disconnected due to changes in the distance and viewing angle between the satellites, an ISL handover may be needed to reroute the satellite connection from LEO satellite 20 to a different LEO satellite. This is another example of an “intersatellite handover.” In most cases, a single satellite connection will undergo multiple handovers, including both network layer and/or link layer handover(s).

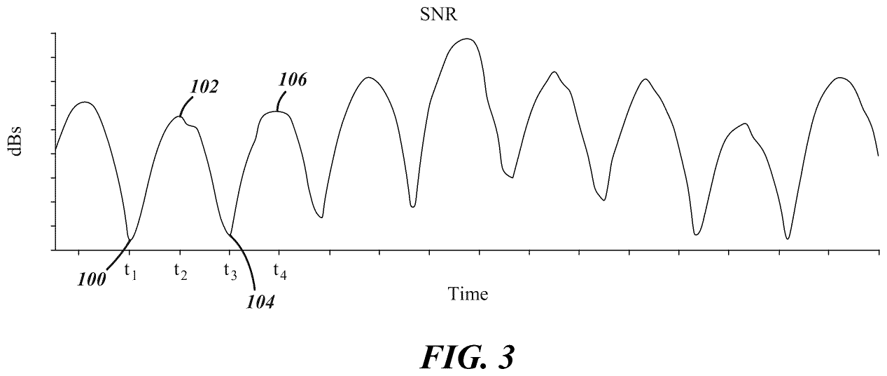

There are various ways to evaluate the quality of a satellite connection, including signal strength. The strength of a connection between a vehicle-mounted user terminal and a LEO satellite tends to vacillate up and down as the user terminal goes through a series of handovers. An example of how this signal strength varies is illustrated in the graph of FIG. 3, which shows time on the x-axis and signal strength on the y-axis, expressed in decibels (dB) as a signal-to-noise ratio (SNR). At time t₁, vehicle-mounted user terminal 60 is connected to LEO satellite 20 and is located near the left-most boundary of a first spotbeam 50 within footprint 40 where the signal strength is not very strong—the SNR of the signal is at a low point 100 (about 0.75 dB) at time t₁. As footprint 40 of LEO satellite 20 moves across the surface of the Earth (leftward direction in FIG. 2), user terminal 60 becomes more centrally located within first spotbeam 50 such that the signal strength increases. This is represented by high point 102 at time t₂ (about 3.25 dB), after which the signal strength begins to fall again as LEO satellite 20 approaches the right-most boundary of the first spotbeam 50, spotbeam boundary 62. At time t₃, the signal strength is at another low point 104 and user terminal 60 needs to undergo a spotbeam handover to transfer the satellite connection to the next spotbeam 52. Following the spotbeam handover, which is an intrasatellite handover, the signal strength once again rises until time t₄ where it peaks at a high point 106 (about 3.4 dB). This vacillating or alternating cycle continues as different spotbeams sweep across vehicle-mounted user terminal 60. When the trailing footprint boundary 64 of the first LEO satellite 20 nears user terminal 60, a satellite handover will be needed to transfer the satellite connection to a second LEO satellite 20′. Various satellite handovers take turns transferring the connection from one LEO satellite to the next. Although the preceding description is focused on spotbeam handovers, it should be recognized that a number of satellite handovers (intersatellite handovers) and/or other handovers may occur as well.

Conventionally, user terminals carried out the above-described handover cycle in an ad-hoc manner. The term “ad-hoc satellite handover,” as used herein, means a satellite handover where a user terminal and backend facility simply scan for available satellites in a particular area, make a satellite selection without significant consideration of the expected future position of the user terminal or of past satellite connections, and then perform the satellite handover as needed. Although ad-hoc satellite handovers may be used in the exemplary handover cycle described above, they typically consume a significant amount of communication resources and are not the most efficient means for transferring satellite communications from one LEO satellite to the next. In addition, when a user terminal is installed on a vehicle that suddenly changes direction or enters an area with limited satellite communication (e.g., a tunnel or other covered area), there may be a disconnection or loss of service. For methods using ad-hoc satellite handovers, this loss of service will cause the user terminal to try and reconnect by scanning for all available satellites, which again consumes a significant amount of communication resources. Instead of performing ad-hoc satellite handovers, the method described herein uses the expected future location of the vehicle-mounted user terminal and history or past satellite connections, as well as other optional factors like the rotation of the Earth, to preemptively devise a “handover plan” that identifies optimum satellite candidates before a satellite handover is urgently required. Such an approach may reduce instances where there is a loss of service, reduce the overall number of satellite handovers needed, and/or better utilize communication resources, and is particularly well suited for user terminals that are installed on vehicles.

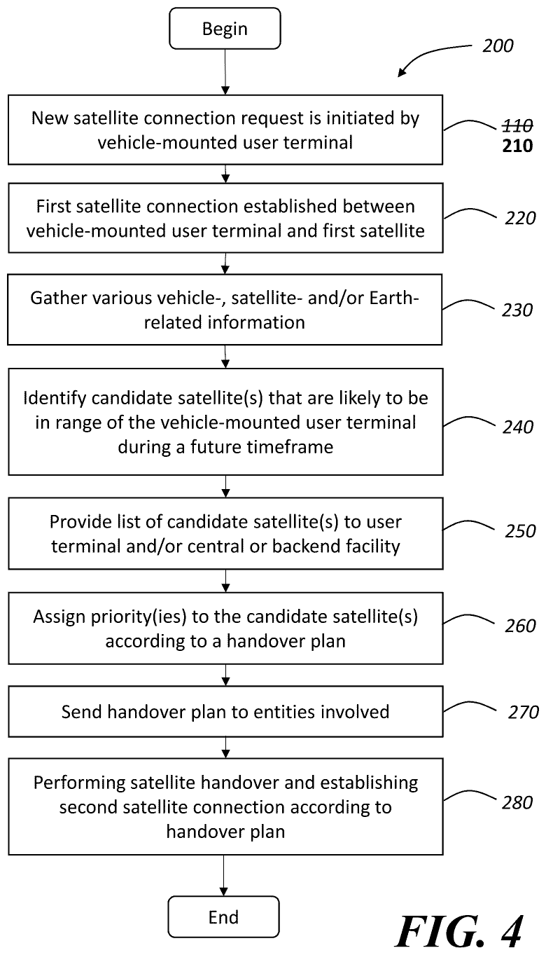

Turning now to FIG. 4, there is shown a flowchart of an exemplary method 200 for satellite communication selection and handover. Starting with step 210, vehicle-mounted user terminal 60 initiates a new satellite connection request with LEO satellite constellation 30. This step could be automatically triggered when the vehicle carrying user terminal 60 is turned on or during some other start-up routine, when a user attempts to engage a feature that requires satellite communication, or when some other trigger event occurs. Furthermore, the process of initiating a new satellite connection request in step 210 can be carried out according to any suitable protocol known in the art, as this step is not limited to any particular technique. Since a new satellite connection request is being initiated for the first time, step 210 may be carried out in an ad-hoc manner that does not give significant consideration to the expected future position of the user terminal or of past satellite connections.

Once the appropriate authentication and handshaking protocols are complete, a new satellite connection is established between the vehicle-mounted user terminal 60 and a first LEO satellite 20, step 220. As footprint 40 of the first LEO satellite 20 quickly traverses across the surface of the Earth, the vehicle-mounted user terminal 60 will inevitable leave one spotbeam or cell and enter another. This transition from spotbeam to spotbeam will require spotbeam handovers, as already described, but the satellite connection between vehicle-mounted user terminal 60 and first LEO satellite 20 should remain for as long as the user terminal is within footprint 40. It should be appreciated that the present method are primarily focused on satellite handovers, thus, any suitable types of spotbeam, ICL and/or other handovers may be employed, even if not explicitly described herein.

Next, the method gathers various types of vehicle-, satellite- and/or Earth-related information, step 230. According to one example, step 230 obtains vehicle navigation information from a vehicle GPS unit, a navigation unit, a telematics unit, a vehicle dynamics module, an external application and/or some other source. Vehicle navigation information may include any combination of the following, for example: a location of the vehicle (e.g., past, present and/or future GPS coordinates for the vehicle); a direction or speed of the vehicle (e.g., past, present and/or future vehicle dynamics data); and a navigational route or destination of the vehicle (e.g., past, present and/or future navigational routes, driving histories or driving patterns). Each “future” piece of information may be predicted or estimated based on known algorithms. The preceding examples of vehicle navigation information provide the present method with some degree of knowledge as to where the vehicle will likely be in the future and can be helpful when developing a handover plan. Step 230 may also gather satellite-related information, such as ephemeris data that provides location, timing and/or status information for various LEO satellites (e.g., past, present and/or future ephemeris data). Ephemeris data may be gathered from a central or backend facility of the LEO satellite constellation 30. Earth-related information, like the direction and rotational velocity of the spin of the Earth, can also be obtained in step 230, as this information can have a bearing on the outcome of the method.

Step 240 then uses the previously gathered information to identify candidate satellites that are likely to be in range of the vehicle-mounted user terminal during a certain future timeframe. The previously gathered information may include vehicle-related information, satellite-related information and Earth-related information. This step may be carried out in any number of different ways using any number of different techniques.

According to one non-limiting example, step 240 creates an area of interest 80 around the current and/or expected future location of the vehicle-mounted user terminal 60. Area of interest 80 may be a virtual area that is defined by a GPS-based perimeter or border and generally represents an area in which the vehicle-mounted user terminal 60 is expected to be during a certain timeframe. The size, shape and/or location of the area of interest 80 will largely be dictated by the vehicle-related information gathered in the previous step. To explain, if vehicle-related information in the form of a navigational route was gathered in step 230, then step 240 may establish an area of interest 80 that conforms to or encompasses the navigational route. Shorter navigational routes with expected timeframes of several minutes will have corresponding areas of interest that are quite small, whereas longer navigational routes that are expected to last several hours will have areas of interest that are significantly larger. Vehicle-related information in the form of vehicle dynamics data can also impact the size, shape and/or location of the area of interest 80. For instance, if the vehicle is driving on a highway at a high rate of speed, then the size of area of interest 80 may be larger than if the vehicle was parked or was being driven at a low speed in a residential area. Again, the area of interest 80 is intended to represent an area in which the vehicle-mounted user terminal 60 will be located during a certain timeframe. If the vehicle makes a sudden turn or veers off the navigational route, then step 240 may have to modify the area of interest 80 or create a new area of interest, based on the new vehicle heading. It is possible for the area of interest 80 to conform to or encompass an entire navigational route, multiple navigational routes, a portion of a navigational route, or just a current and/or expected future location of the vehicle instead of an entire navigational route, to cite a few possibilities.

With the area of interest 80 now established and defined, step 240 can compare satellite-related information to the area of interest in order to determine which LEO satellite(s) are expected to be in range of the vehicle-mounted user terminal during the timeframe corresponding to the area of interest 80. These LEO satellites are referred to as “candidate satellites.” One potential way to do this is to use previously gathered ephemeris data for the LEO satellite constellation 30 and compare or overlay that data with the area of interest 80 in order to build a virtual model of satellite vs user terminal position. This model may take into account Earth-related and/or other information, such as the direction and rotational velocity of the spin of the Earth, and can produce a list of one or more candidate satellite(s) that are expected to be in range of vehicle-mounted user terminal 60 during the timeframe in question. Stated differently, the algorithm used to carry out step 240 identifies an area (potentially a large area) that encompasses or surrounds the expected future location of the vehicle, extrapolates the future locations of LEO satellites which are predictable and generally known, and identifies candidate satellite(s) that are expected to be in range of the vehicle-mounted user terminal during the timeframe in question.

Step 250 provides the list of candidate satellite(s) to the central or backend facility of the LEO satellite constellation 30 and/or to the vehicle-mounted user terminal 60 and is an optional step. If the list is compiled at the central or backend facility, then the method may share the list with the vehicle-mounted user terminal 60 by sending it a wireless signal; conversely, if the list is compiled at the vehicle-mounted user terminal, then the method may share the list with the central or backend facility. The exact manner of how the list of candidate satellite(s) is shared is not critical, as any suitable method may be employed.

Next, the method assigns priority(ies) to the candidate satellite(s) that were previously identified, step 260. The priority(ies) may be assigned based on a number of different factors and can be part of a larger handover plan, which is a predetermined plan for carrying out one or more satellite handover(s) while the vehicle-mounted user terminal 60 is in the area of interest 80. The handover plan is preferably designed to avoid disconnections or losses of service, to reduce the overall number of satellite handovers needed, and/or to better utilize the communication resources of the vehicle-mounted user terminal 60 and/or the LEO satellite constellation 30. To illustrate, step 260 may evaluate the list of candidate satellite(s) previously identified and determine that, based on the expected navigational route of the vehicle and the ephemeris data for the candidate satellite(s), that a loss of service is likely to occur near a certain location and/or at a certain point in time. The anticipated loss of service or disruption in the satellite connection will likely necessitate a satellite handover at some point in the future. It is also possible for the method to consider past satellite connections and/or history when making this evaluation (e.g., if a history of past satellite connections indicates that a loss of service typically occurs in a certain area or at a certain time, or if a certain area is prone to connections with weak signal strengths, then this could also be a factor in the development of the handover plan). Step 260 can then consider the different candidate satellite(s) and prioritize those that are optimal or best suited to carry out the satellite handover, preferably before a loss of service occurs. In one example, the method prioritizes the candidate satellite(s) by ranking them in order of most optimal to least optimal based on the circumstances of the expected loss of service, although other methods of prioritization may be used instead.

In another example, the method considers when each candidate satellite enters and exits the area of interest 80 and prioritizes the satellites such that the overall number of satellite handovers are minimized. A candidate satellite that is expected to be in range of the vehicle-mounted user terminal for a long, sustained period of time may be prioritized over one that is expected to just briefly be in range. The handover plan may include a series or sequence of prioritized satellite handovers (e.g., LEO satellite 20 is first, LEO satellite 26 is second, LEO satellite 24 is third, and so on) or it may just include a single prioritized satellite handover, to cite two possibilities.

The priority(ies) assigned to the different candidate satellites and/or the handover plan are determined by one or more algorithm(s) that may be carried out at the user terminal 60, at the vehicle, at the central or backend facility of the LEO satellite constellation 30, at some other location or at a combination thereof. Once the handover plan is developed, step 270 sends it to the various entities involved, which can include some combination of the vehicle-mounted user terminal 60, the central or backend facility of the LEO satellite constellation 30 and/or the actual candidate satellite(s) themselves. The handover plan may be sent to these different entities via the satellite connection that was established in step 220 or by some other suitable means.

At this point, with the handover plan developed and shared between the different entities involved, the vehicle-mounted user terminal 60 continues along the navigational route with the satellite connection established in step 220 until it is time for a satellite handover. Once that occurs, step 280 will attempt a satellite handover with the first prioritized candidate satellite according to the handover plan, as opposed to performing an ad-hoc handover. If the first prioritized candidate satellite is not in range or is otherwise unavailable, step 280 will attempt a satellite handover with the second prioritized candidate satellite. This process continues according to the handover plan until a successful satellite connection is established.

Performing the satellite handover according to a predetermined handover plan, where a number of candidate satellite(s) have already been identified and prioritized, as opposed to an ad-hoc satellite handover, not only improves the service quality by reducing disconnections and losses in services, it also improves the predictability and efficiency of the system.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method for satellite selection and handover using a vehicle-mounted user terminal and a low Earth orbit (LEO) satellite constellation having a plurality of LEO satellites, the method comprising the steps of:
initiating a new satellite connection request from the vehicle-mounted user terminal to the LEO satellite constellation;
establishing a first satellite connection between the vehicle-mounted user terminal and a first satellite of the plurality of LEO satellites;
gathering vehicle-related information that includes vehicle navigation information and gathering satellite-related information that includes ephemeris data for the plurality of LEO satellites;
using the vehicle-related information and the satellite-related information to identify candidate satellite(s) from the plurality of LEO satellites that are expected to be in range of the vehicle-mounted user terminal during a future timeframe;
prioritizing the candidate satellite(s) for one or more satellite handover(s) to be carried out during the future timeframe; and
performing a satellite handover and establishing a second satellite connection between the vehicle-mounted user terminal and a second satellite of the plurality of LEO satellites, wherein the second satellite is prioritized among the candidate satellite(s).

2. The method of claim 1, wherein the LEO satellite constellation includes a plurality of LEO satellites that orbit the Earth at an altitude less than 3,000 km and have orbital periods less than 2 hours.

3. The method of claim 1, wherein the initiating step further comprises initiating a new satellite connection request in an ad-hoc manner where the vehicle-mounted user terminal scans for available LEO satellites in a particular area and makes a satellite selection without consideration of an expected future position of the user terminal or of past satellite connections.

4. The method of claim 1, wherein the gathering step further comprises gathering vehicle-related information including vehicle navigation information from at least one of the following sources: a vehicle GPS unit, a navigation unit, a telematics unit, a vehicle dynamics module, or an external application, and the vehicle navigation information includes at least one of the following types of data: global positioning system (GPS) coordinates for a current location of the vehicle, GPS coordinates for an expected future location of the vehicle-mounted user terminal, or a navigational route for the vehicle-mounted user terminal.

5. The method of claim 1, wherein the gathering step further comprises gathering Earth-related information, and the Earth-related information includes data pertaining to the rotation of the Earth.

6. The method of claim 1, wherein the using step further comprises using the vehicle-related information to create an area of interest around a current and/or expected future location of the vehicle-mounted user terminal, and using the area of interest to identify candidate satellite(s) that are expected to be in range of the vehicle-mounted user terminal during the future timeframe.

7. The method of claim 6, wherein the area of interest is a virtual area that is defined by a GPS-based perimeter or border and generally represents an area in which the vehicle-mounted user terminal is expected to be during the future timeframe.

8. The method of claim 6, wherein the area of interest conforms to or encompasses a navigational route such that a size, shape and/or location of the area of interest is influenced by the navigational route.

9. The method of claim 6, wherein a size, shape and/or location of the area of interest is influenced by vehicle dynamics data.

10. The method of claim 6, wherein a size, shape and/or location of the area of interest is influenced by the future timeframe.

11. The method of claim 6, wherein the using step further comprises comparing the satellite-related information to the area of interest in order to identify candidate satellite(s) that are expected to be in range of the vehicle-mounted user terminal during the future timeframe.

12. The method of claim 1, wherein the prioritizing step is done at the vehicle-mounted user terminal.

13. The method of claim 11, wherein the using step further comprises taking Earth-related information into account when identifying candidate satellite(s) that are expected to be in range of the vehicle-mounted user terminal during the future timeframe.

14. The method of claim 1, wherein the prioritizing step further comprises prioritizing the candidate satellite(s) according to a handover plan, the handover plan is a predetermined plan for carrying out one or more satellite handover(s) during the future timeframe while the vehicle-mounted user terminal is in an area of interest.

15. The method of claim 14, wherein the handover plan is designed to avoid disconnections or losses of service while the vehicle-mounted user terminal is in the area of interest.

16. The method of claim 14, wherein the handover plan is designed to reduce an overall number of satellite handovers needed while the vehicle-mounted user terminal is in the area of interest.

17. The method of claim 1, wherein the performing step further comprises performing the satellite handover according to a predetermined handover plan, as opposed to an ad-hoc satellite handover.

18. The method of claim 17, wherein the satellite handover is a link layer handover that involves an intersatellite handover.

19. The method of claim 12, wherein the performing step is done at the vehicle-mounted user terminal.
